(19) United States
(12) Patent Application Publication
(10) Pub. No.: US 2008/0003486 A1
(43) Pub. Date: Jan. 3, 2008

(54) CURRENT COLLECTOR BOARD FOR FUEL CELL

(76) Inventors: HSI-MING SHU, Taipei (TW); Tsang-Ming Chang, Taipei (TW); Chun-Wei Pan, Taipei (TW)

Correspondence Address: G. LINK CO., LTD., 3550 BELL ROAD, MINOOKA, IL, 60447, US

(21) Appl. No.: 11/735,514

(22) Filed: Apr. 16, 2007

(30) Foreign Application Priority Data
Apr. 18, 2006 (TW) 095206475

(51) Int. Cl. H01M 4/00

(52) U.S. Cl. 429/44

(57) ABSTRACT

The present invention is a current collector board for fuel cell, which comprises: a substrate providing with at least one current collector area; at least one wiring, which is configured on the surface of the substrate; and, at least one pre-made current collector sheet, which is made of high conductivity material; wherein, these current collector sheet are tightly bonded, and covering these current collector areas of the substrate, and extending for contacting with these wirings.

### FIELD OF THE INVENTION

The present invention relates to an current collector board for fuel cell, and particularly a current collector board providing high current collection capability, which is combined with anti-chemical reaction material, so as to effectively prevent the surface damage by the fuel or electrochemical reaction product.

### BACKGROUND OF THE INVENTION

The fuel cell is a generation device for directly transforming the chemical energy stored in fuel and oxidant into electrical energy through the electrode reaction. There are numerous types of fuel cell, and with different categorization methods. If the fuel cells are categorized by the difference of electrolyte characteristics, there are five types of fuel cells with different electrolytes, such as alkaline fuel cell, phosphorous acid fuel cell, proton exchange membrane fuel cell, molten carbonate fuel cell, solid oxide fuel cell. However, in the electrochemical reaction process of the fuel cell, the current collection capability of the conventional collector board, including anode pallet and cathode pallet, could not reach a very high level, and the capability of anti-erosion or anti-acid for the current collector board long time staying in the fuel and electrochemical reaction product is also not sufficient, so as to affect the life-span. Furthermore, the conventional current collector board not only has the disadvantage of not lighter weight enough, but also has a very complicated manufacturing procedure.

In order to overcome these disadvantages, the present invention discloses a current collector board with high current collection capability and anti-chemical reaction capability.

### SUMMARY OF THE INVENTION

The main object of the present invention is to provide a current collector board for fuel cell, which provides the advantage of high current collection capability.

The secondary object of the present invention is to provide a current collector board for fuel cell, which could effectively prevent the damage on the surface by the fuel or the electrochemical reaction product, and provides the advantages of lighter weight and easy for manufacturing.

To this end, the present invention provides a current collector board for fuel cell, which comprises: a substrate providing with at least one current collector area; at least one wiring, which is configured on the surface of the substrate; and, at least one pre-made current collector sheet, which is made of high conductivity material; wherein, these current collector sheets are tightly bonded, and covering these current collector areas of the substrate, and extending for contacting with these wirings.

### BRIEF DESCRIPTION OF THE DRAWINGS

The above objective and advantages of the present invention will become more apparent with reference to the appended drawings wherein:

FIG. 1 is an exploded view of a fuel cell using the current collector board according to the present invention;

FIG. 2 is an exploded view of the current collector board according to the present invention;

FIG. 3 is an elevation assembly diagram of a varied embodiment for the current collector board in FIG. 2; and

FIG. 4 is an elevation assembly diagram of another varied embodiment for the current collector board in FIG. 2.

### DETAILED DESCRIPTION OF THE INVENTION

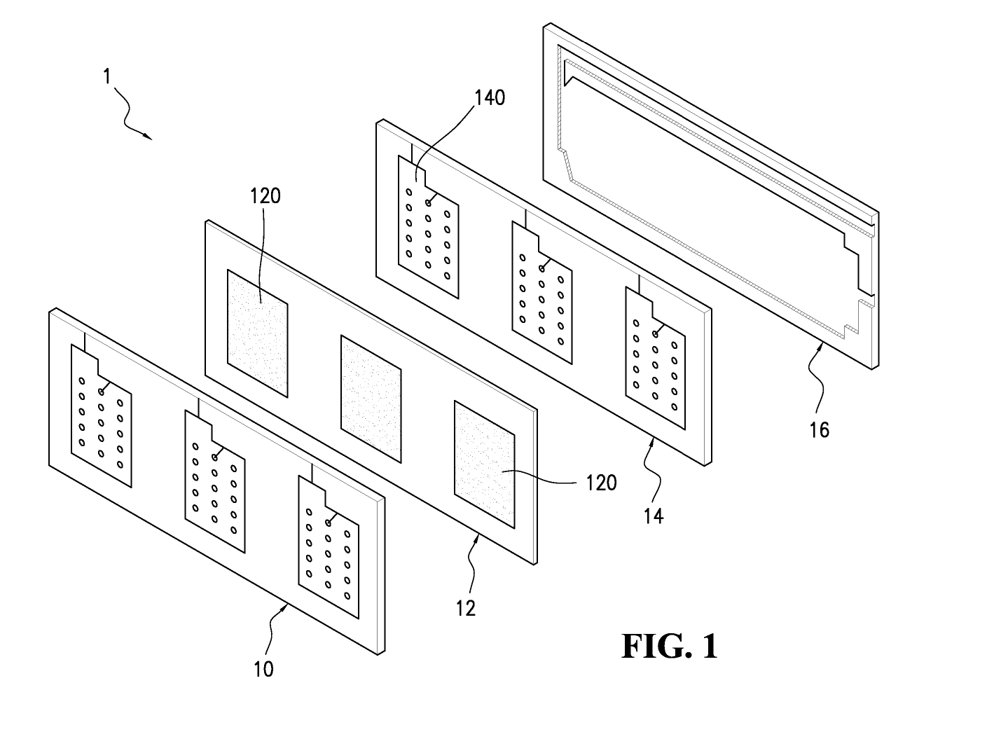

As shown in FIG. 1 in the sequence from left to right, the fuel cell 1 at least comprises: a cathode current collector board 10, a membrane electrode assembly (MEA) board 12, an anode current collector board 14, a flow field board 16; wherein, the MEA board 12 comprises at least one membrane electrode assembly 120, and the board 10 is contacted with the cathodes of MEAs 120.

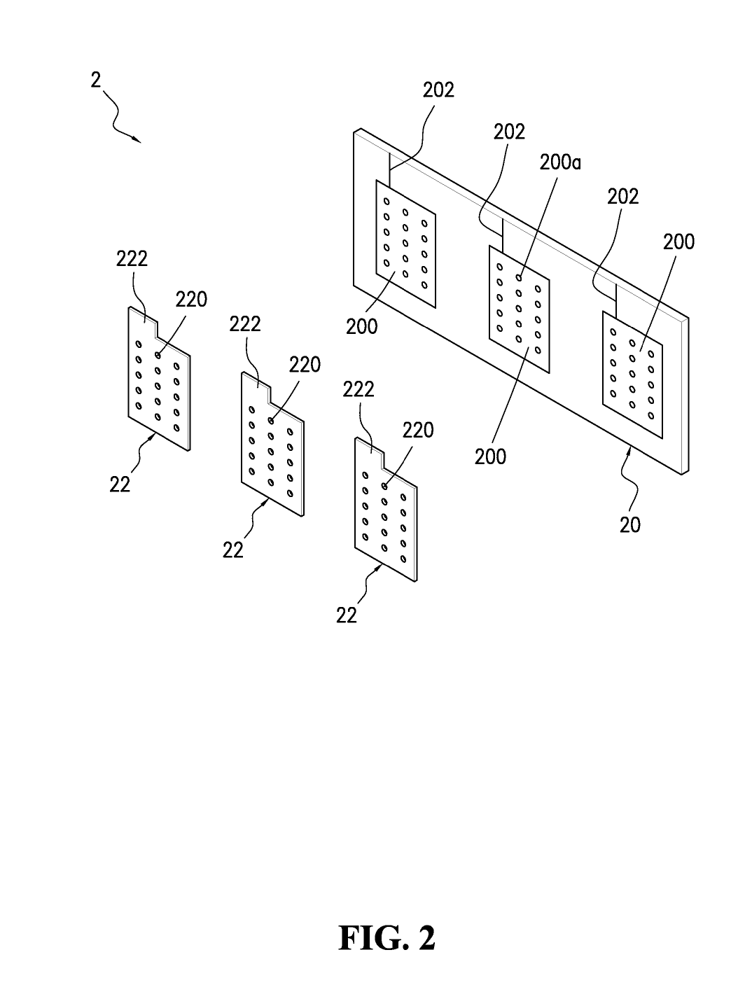

As shown in FIG. 2, the current collector board 2 according to the present invention could be applied for the cathode current collector board 10 and the anode current collector board 14 of the fuel cell 1 in FIG. 1. The current collector board 2 comprises: a substrate 20, the wirings 202, and the current collector sheets 22. The substrate 20 could be fabricated using a printed circuit board, such as selecting one of FR4 substrate, FR5 substrate, epoxy resin substrate, glass-fiber substrate, ceramic substrate, polymer plasticized substrate, and a composite material substrate. As shown in FIG. 2, the substrate 20 is configured with at least one current collector area 200. As for the forming of current collector areas 200, it is first to conduct the process of etching the substrate 20 within the areas of the current collector areas 200 to remove the metal to form insulation areas. The position for each current collector area 200 is corresponding to the position of each membrane electrode set 120 for the fuel cell 1 in FIG. 1. Furthermore, in the thickness direction of the substrate 20, it penetrates a plurality of through-holes 200a on the substrate 20 belonging to the current collector area 200, so that the fuel could be passed through the through-holes 200a onto the membrane electrode set 120; also, the reactant generated after electrochemical reaction from the membrane electrode set 120, such as carbon dioxide, could be passed through the through-holes 200a, and flowed out.

Moreover, the current collector board 2 according to the present invention comprises at least one wiring 202, which is configured on the surface of the substrate 20, and implemented in a printed circuitry.

Furthermore, the current collector board 2 according to the present invention comprises at least one pre-made current collector sheet 22. The current collector sheet 22 employs a high conductivity material, and also an anti-erosion and/or anti-acid resistant material. Such a high conductivity material could be selected from one of stainless steel material, gold material, titanium material, graphite material, carbon metal composite material. As shown in FIG. 1, these current collector sheets 22 are tightly bonded, and covering these current collector areas 200 on the substrate 20, and extending to contact with these wirings 202. As shown in FIG. 2, the current collector sheet 22 has an extension portion 222, which could be contacted with the wiring 202, and electrically connected with the wiring 202, and become the situation of the cathode current collector board 10 and the anode current collector board 14 in FIG. 1 finally. For the implementation of processing procedure, these current collector sheets 22 could be pressed to be tight bonded with the substrate 20 through spot-welding, argon welding, or adhesion method, which employs an adhesive, such as Prepreg resin adhesive sheet, AB glues, etc., for the current collector sheets 22 to be pressed and tightly bonded with the substrate 20.

As shown in FIGS. 1 and 2, the current collector areas 200 on the current collector board 2 according to the present invention could be formed on the substrate of the anode current collector board 14 in the fuel cell 1, and bonded for covering these current collector sheets 140 in these current collector areas 200, which are contacted with the MEAs 120 in the fuel cell 1. Moreover, on the surface of the board 14 contacted with the flow field board 16, the thin metal layer corresponding to the range of these current collector areas 200 could be removed by such as chemical etching, or by applying the protection procedure for anti-erosion and/or anti-acid on the surface of thin metal layer, such as spraying a layer of thin Teflon, or attaching with a Prepreg resin adhesive sheet, or sputtering (electroplating) an anti-erosion metal layer (such as gold, carbon, titanium, and graphite).

Moreover, in FIG. 2, the current collector sheet 22 is configured with more than one through-holes 220 corresponding to the through-holes 200a in the range of current collector area 200, and the form for the through-holes 220 of the current collector sheet 22 is consistent with that of the through-hole 200a in the range of current collector area 200. Thus, the fuel or air could pass through the through-holes 220, and flow into the membrane electrode set 120 through the through-holes 220a of the substrate 20.

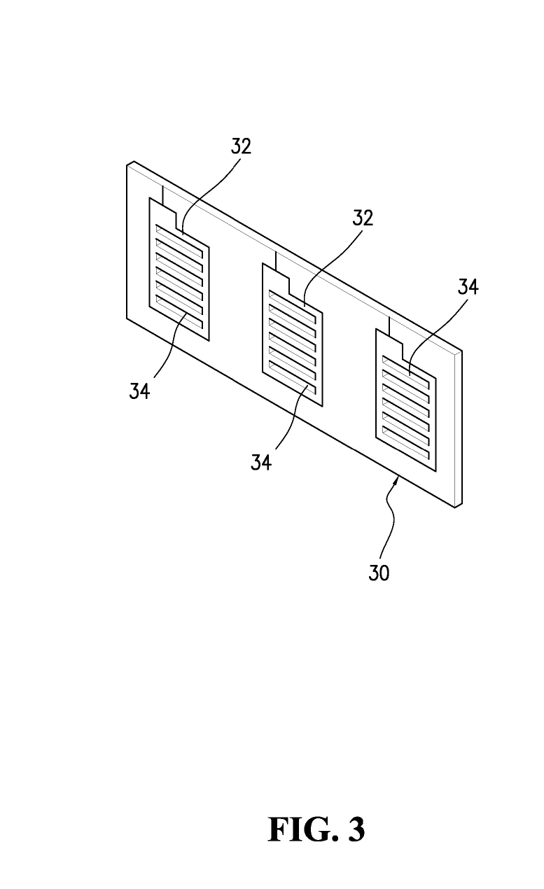

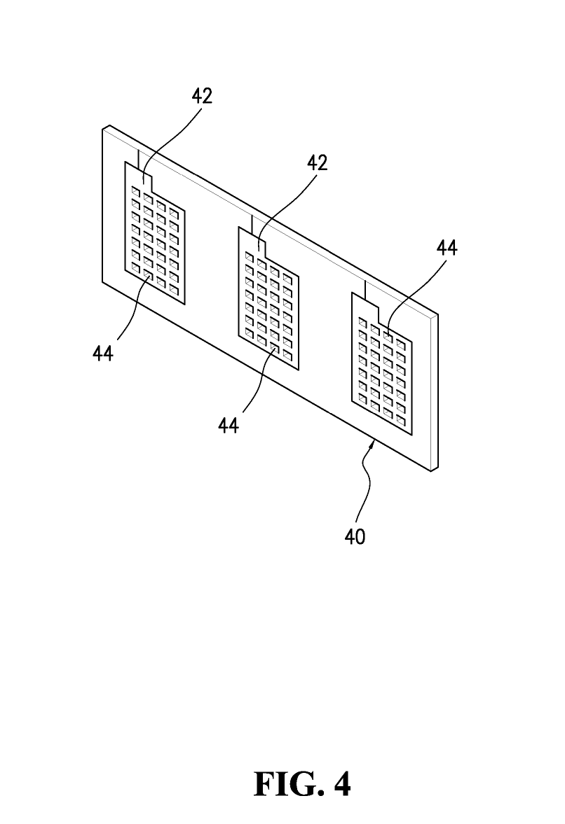

FIG. 3 is an elevation assembly diagram of a varied embodiment for the current collector board in FIG. 2. As shown in FIG. 3, the arrangement of through-holes 34 on the substrate 30 and the current collector sheets 32 is formed as a grid structure. FIG. 4 is an elevation assembly diagram of another varied embodiment for the current collector board in FIG. 2. As shown in FIG. 4, the arrangement of the through-holes 44 on the substrate 40 and the current collector sheets 42 is formed as a net structure. FIG. 3 and FIG. 4 are used to describe that the aspect for the current collector board according to the present invention is not only limited to the form shown in FIG. 2, which could certainly have various forms, and FIGS. 3 and 4 are just one of them.

The current collector board according to the present invention could be applied for different types of fuel cell, such as in the fuel cell using methanol fuel, the fuel cell using liquid fuel, the fuel cell using gas fuel, and the fuel cell using solid fuel. Finally, the features and effects of the present invention could be concluded as follows:

1. The current collector sheets used in the current collector board according to the present invention could provide the features of high conductivity and anti-erosion and/or anti-acid resistance, so that the current collector board according to the present invention could provide excellent current collection capability, and effectively prevent the damage to the surface of the current collector sheets by the fuel, such as methanol, or electrochemical reaction product, so as to reduce the changing rate of fuel cell;

2. The current collector sheets in the current collector board according to the present invention could employ a structure of metal foil. Because the current collector sheet is extremely light and thin, the volume and weight for the current collector board could be greatly reduced, which is beneficial for application of portable electronic product; and

3. The fabrication method for the current collector board according to the present invention employs the pre-made current collector sheets, and the spot-welding or adhesion method to press and tightly bond the current collector sheets with the substrate. For the current processing technology, it is a very convenient and easy fabrication method. Thus, the current collector board according to the present invention is beneficial for mass production.

The present invention has been described with embodiments as above. Thus, the disclosed embodiments are not limiting the scope of the present invention. And, for the skilled in the art, it is well appreciated that the change and modification without departing from the claims of the present invention should be within the spirit and scope of the present invention, and the protection scope of the present invention should be defined with the attached claims.

What is claimed is:

1. A current collector board for fuel cell, which comprises:
a substrate, which provides with at least one current collector area;
at least one wiring, which are configured on the surface of the substrate; and,
at least one pre-made current collector sheet, which is made of high conductivity material, in which these current collector sheets are tightly bonded and covering these current collector areas on the substrate, and extending to contact with these wirings.

2. The current collector board according to claim 1, wherein the current collector sheet is provided with an extension portion, and the extension portion is contacted with the wiring, and electrically connected to the wiring.

3. The current collector board according to claim 1, wherein the substrate is a printed circuit board.

4. The current collector board according to claim 1, wherein the substrate is selected from one of FR4 substrate, FR5 substrate, epoxy resin substrate, glass-fiber substrate, ceramic substrate, polymer plasticized substrate, and a composite material substrate.

5. The current collector board according to claim 1, wherein the high conductivity material is also an anti-erosion and/or anti-acid resistance material.

6. The current collector board according to claim 5, wherein the high conductivity material is selected from one of stainless steel material, gold material, titanium material, graphite material, carbon metal composite material.

7. The current collector board according to claim 1, wherein the substrate is provided with a plurality of through-holes in the range of the current collector area.

8. The current collector board according to claim 7, wherein the current collector sheet is provided with at least one through-hole corresponding to these through-holes in the range of the current collector area, respectively, and the form of these through-holes on the current collector sheet is consistent with that of the through-holes in the range of the current collector area.

9. The current collector board according to claim 7, wherein the arrangement for these through-holes is formed as a grid structure.

10. The current collector board according to claim 7, wherein the arrangement for these through-holes is formed as a net structure.

11. The current collector board according to claim 1, wherein these current collector sheets are pressed and tightly bonded with the substrate through spot-welding, argon welding or adhesion method.

12. The current collector board according to claim 1, wherein the wiring is a printed circuitry.

13. The current collector board according to claim 11, wherein these current collector sheets are pressed and tightly bonded with the substrate using an adhesive.

14. The current collector board according to claim 13, wherein the adhesive is a Prepreg resin adhesive sheet.

15. The current collector board according to claim 13, wherein the adhesive is an AB glue.
